(19) United States
(12) Patent Application Publication
(10) Pub. No.: US 2008/0025829 A1
(43) Pub. Date: Jan. 31, 2008

(54) Highway Vehicle for Handicapped Drivers in Mobility

(76) Inventor: Orville Douglas Denison, Monrovia, CA (US)

Correspondence Address: LOUIS VENTRE, JR, 2483 OAKTON HILLS DRIVE, OAKTON, VA, 22124-1530, US

(21) Appl. No.: 11/550,615

(22) Filed: Oct. 18, 2006

Related U.S. Application Data
(63) Continuation-in-part of application No. 11/309,347, filed on Jul. 28, 2006, now abandoned.

(51) Int. Cl. B60P 1/00

(52) U.S. Cl. 414/537

(57) ABSTRACT

A highway motor vehicle is equipped to be driven by a handicapped person in a mobility chair. The preferred embodiment permits rear passenger seating commonly found in automobiles and includes a rear stowage compartment for purchased items. The vehicle has a powered hatch and ramp. This hatch and ramp permit a handicapped person to enter to the driving position in a wheelchair. Wheelchair wheel locks and seatbelts secure the wheelchair and handicapped person in place in the driver's position in the vehicle. The hatch is closable and the ramp withdrawable so that the vehicle is drivable on the highway. Collapsible and rotatable steering controls are either part of the front hatch or are rotatably mounted to the floor and moved into a position in front of the driver. Steering and other operational controls may be geared or electronic to suit the handicapped person's abilities.

This is a continuation-in-part application and claims the benefit of co-pending U.S. application Ser. No. 11/309347, filed Jul. 28, 2006, now abandoned, the complete disclosure of which is incorporated herein by reference.

### BACKGROUND OF THE INVENTION

1. Field of Invention

In the field of vehicles for the handicapped, a vehicle for highway travel to be driven by the physically challenged seated in a wheelchair or other mobility device.

Handicapped people have found new mobility in using hand-powered and electrically-power wheelchairs, scooters, and other powered mobility devices, which are referred to herein generally as wheelchairs. In the United States and much of the rest of the world, even with such wheelchairs, mobility beyond proximity to the home is still difficult for a handicapped person and may present so many obstacles that it is virtually unavailable to the handicapped without assistance.

The process of a self-sufficient handicapped person driving on the highways can be cumbersome and often stressful. First the handicapped person must get into a wheelchair to travel to the vehicle. Then, the handicapped person must get out of the wheelchair and into the vehicle. The wheelchair must them be stowed in the vehicle. More than likely, one of the often cumbersome methods of lifting the wheelchair and person into the vehicle is first performed and then the person exits the wheelchair and gets into a drivers position. Then, once at the destination, the effort is largely reversed.

Oftentimes, the handicapped person must depend on a loved one or other assistant to lessen the physical burden in accomplishing these tasks. While this is reality, it would greatly increase the independence and self-sufficiency of the handicapped person if the process were made simpler. A goal of the invention is to enable a handicapped person to simply press a button and have the vehicle open in such a way that the person in the wheelchair could simply roll into the vehicle at the driver's position. Then, the handicapped person remaining in the wheelchair locks the wheelchair in place, buckles up, presses another button to close the vehicle and drives off.

2. Description of Prior Art

There are numerous prior art patents and patent applications covering devices for vehicular use by handicapped persons. The vast majority of these involve means for assisting the transfer of an individual into the vehicle. Others involve lifting and carrying the wheelchair or mobility device in or on a standard automobile, minivan or bus. There are two general concepts in the prior art teaching means that enable a handicapped driver to gain access to the driver's position. These are discussed below in two representative patents. In general, this prior art employs complicated processes requiring lifting and attachment steps that detract from their usability and usefulness.

Representative of one type of prior art is U.S. Pat. No. 4,671,730 to Eugene Gateau on Jun. 9, 1987 for a “Vehicle of use in particular to a disabled person.” The disclosure describes a motor vehicle modified with a powered platform to lift a disabled person in a wheeled chair to a level to access the vehicle through a rear hatch and be guided to the front of the vehicle which is a sunken area to accommodate the extra headroom needed for a person in a chair. When at the front of the vehicle, the platform is slid sideways either to the driver or passenger position.

The present invention has several advantages and is distinctly different from the Gateau patent. The present invention employs a front hatch that is powered to lift up and out of the way for direct and easy access to the driving area of the vehicle. A powered ramp extends to the ground from under the front floor area providing an easily navigated platform from the ground level into the vehicle. The handicapped person uses the ramp, preferably with an electrically powered mobility vehicle or wheelchair, to roll into the vehicle using power independent of the vehicle. The ramp angle is controllable so that the ramp can be set at curb level or to street level. Gateau's rear lifting mechanism, guide rails and cluttered rear area are avoided.

In addition, the present invention enables, but does not require, a rear passenger compartment and a stowage, or storage, area similar to conventional vehicles. An embodiment of the present invention enables a handicapped person to travel with passengers and have room to carry groceries or purchased items without getting in the way of the loading and positioning mechanisms.

A second type of prior art involving loading the wheelchair and person into the driver's position is U.S. Pat. No. 5,466,111 to Rudolf X. Meyer on Nov. 14, 1995. The Meyer disclosure teaches a lifting mechanism attached to the driver's door. A special wheelchair is attachable to the front door when in an open position. Using a seat-height adjustment mechanism of the special wheelchair that varies the height of the seat of the wheelchair relative to its wheels, the wheels of the wheelchair are lifted from the ground above the car frame. When the door is closed, the wheelchair is positioned inside the vehicle in an unassisted manner by the occupant. Reversing the sequence unloads the wheelchair and its occupant from the vehicle.

The Meyer invention purportedly allows a handicapped person to transfer his or her wheelchair (with the handicapped user seated thereon) into and out of a vehicle without assistance from others and without major or expensive modifications to a standard vehicle. However, it requires physically complicated maneuvers for a handicapped person to attach his wheelchair to the vehicle door. It further teaches a means that is applicable only to those wheelchairs having certain seat raising and lowering capabilities. It requires physical efforts of the handicapped person to rotate the door closed to gain access to the vehicle.

In contrast, the present invention works with an electrically-powered wheelchair or a hand-powered wheelchair: No special wheelchair is required. The present invention does not require the handicapped person to attach a wheelchair to any mechanism to enable access to the vehicle: No physically challenging connection operations are required to gain access. The present invention enables access by a powered ramp and hatch that may be electronically activated much like the push button unlocking operation commonly used for electronic car door locks. The present invention greatly simplifies the process for a handicapped person well beyond the Meyer disclosure and the type of prior art it represents.

Accordingly, the present invention will serve to improve the state of the art by providing the means to lessen the burdens on a handicapped person in driving a vehicle. It enables a handicapped driver to avoid physically challenging transitions to and from their wheelchair and to easily enter and exit a motor vehicle capable of highway transit. It simplifies the travel process to the point that a handicapped person gains in self-sufficiency and independence. Finally, for some embodiments, it enables a handicapped person to operate a motor vehicle using electronic controls that are especially suited to the handicapped.

### BRIEF SUMMARY OF THE INVENTION

A highway motor vehicle is equipped to be driven by a handicapped person in a mobility chair. The preferred embodiment permits rear passenger seating commonly found in automobiles and includes a rear stowage compartment for purchased items. The vehicle has a powered front hatch and ramp. This hatch and ramp permit a handicapped person to enter to the driving position in a wheelchair. Wheelchair locks and a seatbelt secure the wheelchair and handicapped person in place in the driver's position in the vehicle. The front hatch is closable and the ramp withdrawable so that the vehicle is drivable on the highway. Collapsible and rotatable steering controls are either part of the front hatch or are rotatably mounted to the floor and moved into a position in front of the driver. Steering and other operational controls may be geared or electronic to suit the handicapped person's abilities.

### BRIEF DESCRIPTION OF THE DRAWINGS

FIG. 1 is a perspective of the preferred embodiment of the vehicle with passenger seating behind the driver.

FIG. 2 is a perspective of the preferred embodiment of the vehicle with the front hatch and ramp in the opened position.

FIG. 3 is a perspective of the preferred embodiment of the rear of the vehicle showing an opened rear hatch and a stowage compartment.

FIG. 4 is a perspective of the preferred embodiment of the rear of the vehicle showing a closed rear hatch with an electronic message display near the top of the hatch.

FIG. 5 is a cut-away top view of an alternative embodiment of a vehicle showing a rear ramp.

### DETAILED DESCRIPTION

The invention is a highway motor vehicle, which provides a new level of simplicity, easy access and use by a handicapped driver seated in a human powered or electric powered wheelchair. There are four components to the invention: a hatch, a ramp, vehicle controls, and means for securing the person and wheelchair in place.

FIG. 1 illustrates the preferred embodiment of the vehicle with a passenger seat behind the driver. The handicapped person in a wheelchair (11) is seated in the driving position employing the standard controls (10). As with the usual capabilities of an automobile, sport utility vehicle, light truck, or van, the invention may be driven on city streets or a highway.

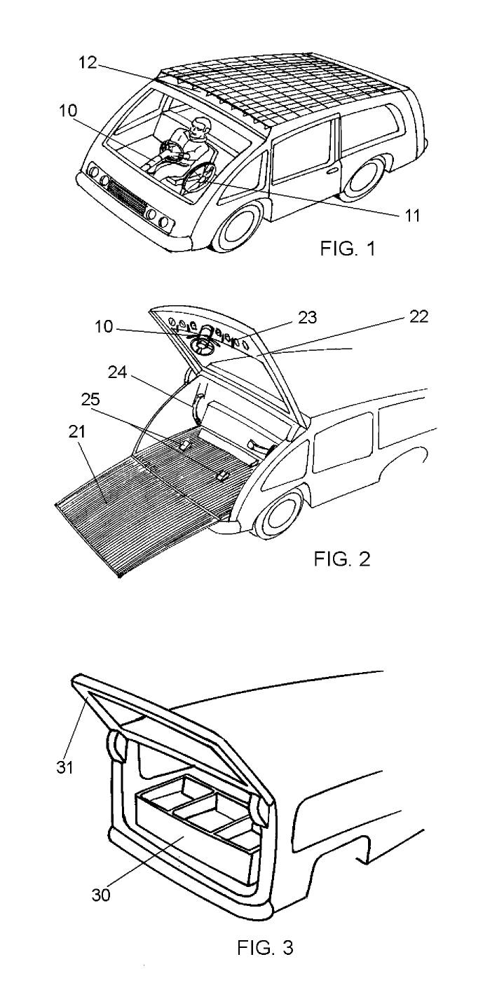

Hatch. The highway motor vehicle for a handicapped driver includes a hatch hinged on the front of the motor vehicle to open and provide access to a driver's position at the front of the vehicle. FIG. 2 illustrates a hatch (22) in the open position. In the preferred embodiment, the hatch (22) is virtually the whole front end of the vehicle and it opens by rotation about one or more upper hinges. Alternative embodiments employ one or more side hinges so that the hatch opens in a manner similar to a car door.

In an alternative embodiment, a hatch is hinged on the rear of the motor vehicle to open and provide access and egress via the rear of the motor vehicle.

Ramp. The vehicle includes a ramp (21), shown in the extended position in FIG. 2. The ramp is deployable to form an access platform extending from an inside front floor of the vehicle to a surface level in front of the vehicle such that a handicapped person in a wheelchair can access the vehicle by riding the wheelchair atop the platform and through an open hatch.

In alternative embodiments, one example of which is illustrated in FIG. 5, which shows a top view of a vehicle without its top. The ramp (21) is similarly deployable and extends from an inside rear floor of the vehicle to a surface level at the rear of the vehicle such that a handicapped person in a wheelchair can access the vehicle by riding the wheelchair atop the platform and through an open rear hatch (not shown).

FIG. 5 shows optional side-wall containers (51) for package storage. These are illustrated in front of rear wheel wells (56) along both sides to accommodate groceries. Such containers may also be positioned above rear wheel wells (56) as space allows. FIG. 5 shows optional passenger side-wall seating (52), which may be selected provided the vehicle is wide enough for a wheel chair to pass.

Embodiments with a rear hatch preferably have no front hatch so that vehicle steering and controls are not movable, although variations with a combination front and rear hatch are within the scope of the invention. A vehicle with a rear hatch and no front hatch would more easily accommodate a front wheel drive or a traditional front-end motor.

FIG. 5 shows a vehicle with an optional powered rotary table (53) capable of rotating the handicapped person in a wheelchair about a central access point, for example to face the opposite direction without moving the wheelchair wheels. The potential direction of rotation is represented by a double-ended arrow (54). A rotary table would be used, for example, to rotate the wheelchair 180 degrees to position a driver toward the rear, so exit would be easier. The rotary table is optionally movable along a fixed track between the front driving position and the rear exit position as represented by the double-ended arrow (55).

A rear hatch has advantages in some vehicle uses, for example when arriving at a destination in a parking lot or garage, the front of the vehicle may be parked head in, against a curb, abutment or another vehicle, rather than having to be backed-in, and the driver could exit the rear of the vehicle and easily navigate to the driving lane and toward the destination. For the less than wheelchair-bound person, this vehicle could be offered with a driver's seat on the rotating platform that would be useful to provide an improved view from a wrap around windshield and a vehicle that is easier to enter, see from and manipulate.

In the preferred embodiment, the ramp is stowed within the vehicle below the hatch and is not visible during vehicle operation, as is apparent by reference to FIG. 1. The ramp can be used to access any level in front of the vehicle. Typically, this level would be at the same or lower elevation than the front floor area. Thus, the ramp could be deployed to a curb or other surface higher than street level as may be convenient. In addition, the ramp would typically have a top surface that is textured to promote wheelchair traction.

For the preferred embodiment, the hatch and ramp are deployed and retracted by a remotely-controlled powered means known in the art, for example by an electric motor or hydraulic mechanism. A typical remote control would operate by the press of a button in a manner similar to that of a garage door opener or a car-door unlocking control mechanism commonly in use today. As with typical remote control units, it would be hand held and work from a distance, including inside or outside the vehicle. In use, the handicapped person would ride on the ramp into the front, or driver's area of the vehicle. The front area would preferably be large enough to permit entry facing forward or backward. For example, if the person in a wheelchair enters the front area facing the rear of the vehicle, the person would then preferably have sufficient room to rotate the wheelchair to face the front, to be in the normal driving position.

Vehicle Controls. The preferred embodiment employs vehicle controls, including instruments such as the speedometer, steering wheel (10), speed, breaking and other vehicle controls that lower into position in front of a handicapped driver seated in a wheelchair in the driver's position. These may be electronic controls, mechanical controls or a combination of electronic and mechanical controls. A speedometer and other instruments (23) are preferably located on the inside hatch wall. Speed and braking are preferably electrically controlled functions of levers on a steering stalk as illustrated in FIG. 2. If electronic controls, known in the art, are employed they may be wired or wireless and would typically be an integral part of the hatch.

In alternative embodiments, a traditional steering wheel mounted on the floor at the side of the vehicle has an articulation joint to permit movement about the joint in a vertical direction, may be telescoped out and in, and is horizontally rotatable in an approximate 90 degree arc between the driving position in front of the seated handicapped person and the vehicle wall. In this embodiment, the steering wheel would be placed against the wall of the vehicle to permit obstruction-free entrance to, and exit from, the vehicle. Thus, for some of these alternative embodiments, the vehicle controls are mounted to the floor on a steering stalk that may be articulated about a joint, telescoped to a collapsed position and rotated to the side of the vehicle to permit the handicapped person in a wheelchair unobstructed entry to, and exit from, the vehicle.

In the preferred and alternative embodiments, the steering wheel may be employed using the traditional mechanical steering linkage or using electronic steering wherein turning the steering wheel activates electronic sensors or micro-switches that move the wheels electronically to the left or right for steering.

Means for Securing. The preferred embodiment has means for securing which separately locks the wheelchair in place and which provides a seat belt securing mechanism (24) for the driver. For the preferred embodiment, the means for securing are wheel stops (25), as shown in FIG. 2, in the floor of the vehicle to receive the wheels of the wheelchair. The means for securing further includes electronically activated wheel locks that pop up to secure the wheels of the wheelchair. Alternative embodiments include manual wheel locks to accommodate the anticipated variability of wheels on mobility chairs. One embodiment has manual wheel locks that are wheelchair wheel clamps that engage the wheels so that the wheelchair may not move about during driving. In addition, the means for securing includes the a seat belt securing mechanism, that is, a typical seat belt mechanism appropriately lengthened and configured to fit around the driver in a wheelchair.

Passenger compartment. The preferred embodiment of the vehicle permits rear passenger seating commonly found in automobiles and includes a rear stowage, or storage, compartment for purchased items. Alternative embodiments have no passenger seating and a rear stowage compartment, or no passenger seating and no stowage compartment.

The preferred personal vehicle has storage in the rear, no rear seats, no side doors. Most of the interior room in this embodiment is for the wheel chair and room to rotate about to face front. The personal vehicle has a short wheel base, which provides a short turning radius for easy parking and maneuvering.

Rear Hatch. An alternative embodiment of the vehicle is shown in FIG. 3 to include a rear hatch (31) on the vehicle providing access to a storage area (30) at the rear of the vehicle. In some of these embodiments, the rear hatch (31) is remotely controlled in the same manner as the front hatch.

Since the invention is intended to be driven by handicapped persons, alternative embodiments of the invention should include features or accessories that would prove useful to a driver in distress. The typical accessories include a one button 911 connection with voice activated speaker. A satellite communication cell phone and radio would be built-in so that there would be no black out areas or shadow areas that might prohibit connection to emergency services.

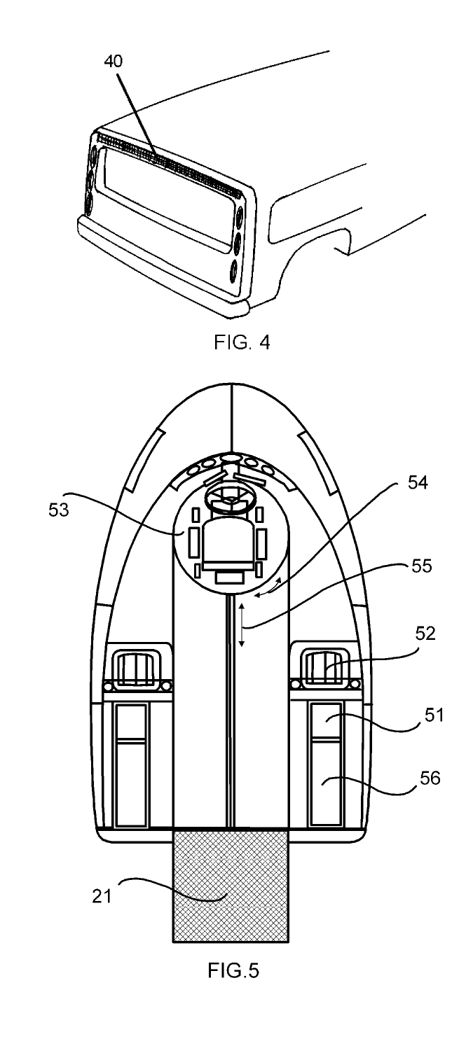

Electronic Sign. An alternative embodiment of the invention includes an electronic message board (40) at the rear of the vehicle as shown in FIG. 4. The message board or screen has the capability to display typed or preset messages to passing motorists that would relay a need for help.

Powerplant. The vehicle's front access requires a powerplant location that is different from the traditional location at the front of the car. In general, a motor may be located on an axle, at each wheel, in the lengthwise midpoint of the vehicle, or at the rear of the vehicle.

A mid-vehicle motor or mid-vehicle battery storage area is enclosed and isolated from the passenger area. This design maintains a low center of gravity for the vehicle to minimize the potential for vehicle roll over in an accident. The rear storage area is then immediately to the rear of enclosed area.

Up to four electric motors may be used to drive the wheels, or a single motor may be used to drive two wheels. In some embodiments, solar cells on the roof of the vehicle provide electricity when the vehicle is in the sun, such electricity being for any vehicle use, including for example to charge one or more batteries and to power a cooling ventilation fan to keep the inside temperature near the outside ambient temperature.

An internal combustion engine, hybrid gasoline engine and electric motor, hybrid diesel engine and electric motor, diesel engine, and fuel cell, such as a carbon or hydrogen fuel cell might also be used as the powerplant. For these embodiments, air scoops extending outwardly from the vehicle body may be employed. For mid-vehicle engine placement the air scoops (12) would preferentially be located just above the roof line, as shown in FIG. 1, to funnel air to the engine via ducts transiting the inside of the vehicle to the mid-vehicle engine placement.

In order to provide access to a vehicle chassis and motor for service, one embodiment has of a vehicle body shell made of a fiberglass outside layer with a foam core. An alternative embodiment has a vehicle body shell made of end grain balsa wood core and fiberglass inside layer. Another alternative embodiment has a vehicle body made of more traditional materials, for example metals such as aluminum or steel, or plastics. These vehicle body options may be combined with a vehicle body shell having hinging at the aft section. The vehicle body is then rotatable about the hinging by activating an electric motor to lift the front of the vehicle body shell to provide access to the vehicle powerplant.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A highway motor vehicle for a handicapped driver comprising,
(a) a hatch hinged on the motor vehicle to open and provide access to a driver's position at the front of the vehicle;
(b) a ramp deployable to form an access platform from an inside floor of the vehicle to a surface level outside the vehicle such that a handicapped person in a wheelchair can access the vehicle by riding the wheelchair atop the platform and through an open hatch;
(c) vehicle controls in front of a handicapped driver seated in a wheelchair in the driver's position; and,
(d) means for securing which separately locks the wheelchair in place and which provides a seat belt securing mechanism for the driver.

2. The vehicle of claim 1 wherein the hatch is hinged at the top of the vehicle and the hatch and ramp are controlled by a powered device.

3. The vehicle of claim 2 further comprising a hand held remote control unit for the powered device.

4. The vehicle of claim 1 wherein the hatch is hinged at the side of the vehicle.

5. The vehicle of claim 1 wherein the ramp is stowable in the vehicle below the hatch.

6. The vehicle of claim 1 wherein vehicle controls are mounted on the hatch and lower into position when the hatch is closed.

7. The vehicle of claim 1 wherein vehicle controls are mounted to the floor on a steering stalk that may be articulated about a joint, telescoped to a collapsed position and rotated to the side of the vehicle to permit the handicapped person in a wheelchair unobstructed entry to, and exit from, the vehicle.

8. The vehicle of claim 1 further comprising a passenger compartment behind the driver's position.

9. The vehicle of claim 1 further comprising side-wall containers for package storage.

10. The vehicle of claim 1 further comprising passenger side-wall seating.

11. The vehicle of claim 1 further comprising a second hatch at opposite ends of the vehicle such that there is a front hatch and a rear hatch on the vehicle.

12. The vehicle of claim 1 further comprising a powered rotary table capable of rotating the handicapped driver in a wheelchair about a central access point.

13. The vehicle of claim 12 wherein the powered rotary table is movable along a fixed track between the front driving position and the rear exit position.

14. The vehicle of claim 1 further comprising an electronic message board at the rear of the vehicle.

15. The electronic message board of claim 14 having the capability to display prerecorded messages and ad hoc messages entered by an occupant of the vehicle.

16. The vehicle of claim 1 wherein a motor for the vehicle is selected from a group consisting of an electric motor powered by batteries, an internal combustion engine, hybrid gasoline engine and electric motor, hybrid diesel engine and electric motor, diesel engine, and fuel cell.

17. The vehicle of claim 16 wherein the electric motor is supplied with electricity from batteries located below the floor of the vehicle.

18. The vehicle of claim 16 further comprising solar cells on the roof of the vehicle to provide electricity for storage or use in the vehicle when the vehicle is in the sun.

19. The vehicle of claim 16 wherein the fuel cell is a hydrogen fuel cell.

20. The vehicle of claim 16 further comprising a vehicle body shell made of a material composition selected from a group consisting of fiberglass with a foam core, end grain balsa wood core and fiberglass inside layer, metals and plastic, said vehicle body shell having hinging at the aft section and rotatable about said hinging by activating an electric motor to lift the front of the vehicle body shell to provide access to the vehicle motor.
